(19) United States
(12) Patent Application Publication
(10) Pub. No.: US 2006/0147210 A1
(43) Pub. Date: Jul. 6, 2006

(54) Wavelength-division-multiplexed passive optical network

(75) Inventors: Seung-Woo Kim, Anyang-si (KR); Jeong-Seok Lee, Anyang-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/250,228

(22) Filed: Oct. 14, 2005

(30) Foreign Application Priority Data
Jan. 3, 2005 (KR) 2005-111

(51) Int. Cl. H04J 14/00

(52) U.S. Cl. 398/71

(57) ABSTRACT

A broadband light source includes: at least two semiconductor optical active devices for generating TE polarized lights of different wavelength bands; an optical coupler for dividing each of the TE polarized lights input from each of the semiconductor optical active devices into two TE polarized lights, and outputting the two TE polarized lights, the two TE polarized lights including a first TE polarized light and a second TE polarized light; a first optical line for transmitting the first TE polarized light, while maintaining a polarization mode of the first TE polarized light; a second optical line for converting the second TE polarized light into a TM polarized light; a polarization beam combiner for combining the first TE polarized light and the TM polarized light to generate a polarization-independent light; and a band separator for separating and outputting the polarization-independent light according to wavelength bands.

### CLAIM OF PRIORITY

This application claims to the benefit under 35 U.S.C. 119 of an application entitled “Wavelength-Division-Multiplexed Passive Optical Network,” filed in the Korean Intellectual Property Office on Jan. 3, 2005 and assigned Serial No. 2005-111, the entire contents of which are incorporated herein by reference.

### BACKGROUND OF THE INVENTION

1. Field of the Invention

The present invention relates to a semiconductor optical device, and more particularly to an active-type semiconductor optical device capable of generating a broad wavelength band light.

2. Description of the Related Art

In general, broadband light sources capable of generating a broad band light include an erbium-doped optical fiber amplifier and a semiconductor optical active device which may be used to generate wavelength-locked optical signals in a wavelength-division-multiplexed optical network or may be used as a spectrum-sliced light source. In the wavelength-division-multiplexed optical network, an optical signal having a distinct wavelength is allocated to each of multiple optical network units so as to be used in an optical communication. That is, according to the wavelength-division-multiplexed optical network, light of a specific wavelength band is divided into a plurality of channels having different wavelengths, and data is loaded in a corresponding channel to be transmitted. Therefore, in the wavelength-division-multiplexed optical network, the wider the wavelength band of a light becomes, the easier the expansion of lines becomes. However, the erbium-doped optical fiber amplifier has limited wavelengths and has a problem in that it has high fabrication costs and large volume. The erbium-doped optical fiber amplifier stably generates a high-power polarization-insensitive light, but is largely limited in selection of a wavelength band and range as compared with the semiconductor optical active device.

In contrast, the semiconductor optical active device has advantages in that the wavelength band and range can be simply selected and miniaturization is possible, but has drawbacks in that it has relatively poor characteristics in output, polarization, and spectrum. However, a light generated from the semiconductor optical active device has a large polarization dependence, which limits the application in an optical communication network.

In order to decrease the polarization dependence of the semiconductor optical active device, a method of controlling the polarization component of light by applying strain to a bulk active structure instead of a quantum-well active structure has been proposed. However, it is practically impossible to precisely control the polarization mode of light, and also it is impossible to completely eliminate all polarization dependence without causing a decrease in the yield of products due to inherent characteristic of the semiconductor devices. Accordingly, the high polarization dependence of the semiconductor optical active device has many disadvantages.

### SUMMARY OF THE INVENTION

Accordingly, the present invention has been made to solve the above-mentioned problems occurring in the prior art and provides additional advantages, by providing e a broadband light source capable of eliminating a polarization dependence of light having a broad wavelength band generated from a semiconductor optical active device.

In one embodiment, there is provided a broadband light source comprising: at least two semiconductor optical active devices for generating TE polarized lights of different wavelength bands; an optical coupler for dividing each of the TE polarized lights input from each of the semiconductor optical active devices into two TE polarized lights, and outputting the two TE polarized lights, the two TE polarized lights including a first TE polarized light and a second TE polarized light; a first optical line for transmitting the first TE polarized light, while maintaining a polarization mode of the first TE polarized light; a second optical line for converting the second TE polarized light into a TM polarized light; a polarization beam combiner for combining the first TE polarized light and the TM polarized light to generate a polarization-independent light; and a band separator for separating and outputting the polarization-independent light according to wavelength bands.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a configuration of a broadband light source according to a first embodiment of the present invention;

FIG. 2 is a block diagram illustrating a configuration of a broadband light source according to a second embodiment of the present invention; and

FIG. 3 is a block diagram illustrating a passive optical network including a broadband light source according to a third embodiment of the present invention.

### DETAILED DESCRIPTION

Hereinafter, embodiments according to the present invention will be described with reference to the accompanying drawings. For the purposes of clarity and simplicity, a detailed description of known functions and configurations incorporated herein will be omitted as it may obscure the subject matter of the present invention.

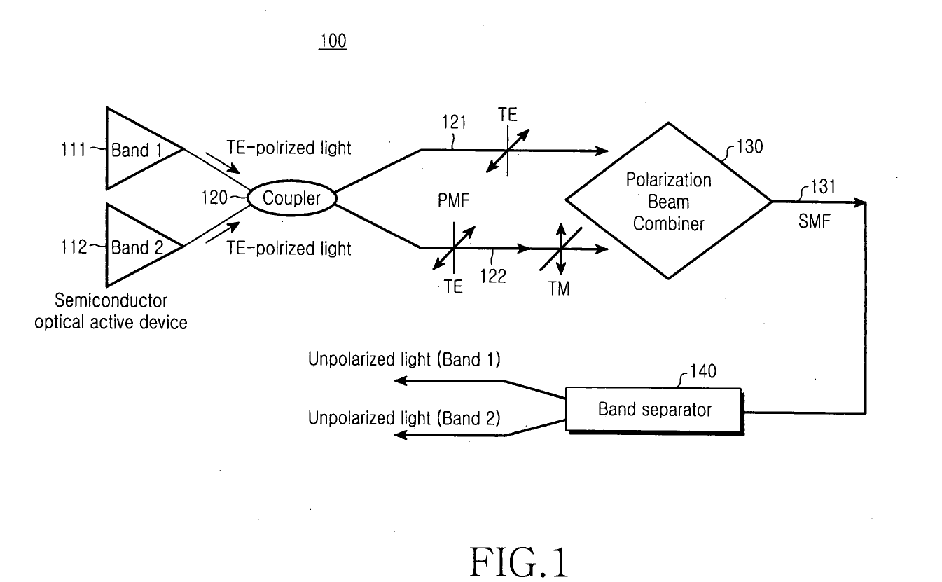

FIG. 1 is a block diagram illustrating the configuration of a broadband light source according to a first embodiment of the present invention.

As shown, the broadband light source 100 includes two or more semiconductor optical active devices 111 and 112, an optical coupler 120, first and second optical lines 121 and 122, a polarization beam combiner 130, a band separator 140, and a single-mode optical fiber 131. The single-mode optical fiber 131 is located between the polarization beam combiner 130 and the band separator 140 and transmits a polarization-independent light to the band separator 140.

The semiconductor optical active devices 111 and 112 may include a superluminescent diode (SLD), a semiconductor optical amplifier (SOA), or other equivalent optical device capble of generating a light of a specific polarization mode. The semiconductor optical active devices 111 and 112 generate TE polarized lights having wavelength bands different from each other.

The optical coupler 120 divides each of the TE polarized lights input from the semiconductor optical active devices 111 and 112 into two TE polarized lights, then outputs the divided two TE polarized lights (including a first TE polarized light and a second TE polarized light) to corresponding paths, respectively. The optical coupler 120 may include a 2×2 optical coupler.

The first and second optical lines 121 and 122 may include a polarization-maintaining optical fiber. The first optical line 121 transmits the first TE polarized light, which is one of the divided TE polarized lights, while maintaining the polarization mode of the first TE polarized light. The second optical line 122 includes a polarization-maintaining optical fiber, which is rotated 90° about the axis of the TE polarization. Therefore, the second optical line 122 converts the second TE polarized light, which is the other of the two divided TE polarized lights, into a TM polarized light, and outputs the TM polarized light.

The polarization beam combiner 130 combines each of the TE polarized lights and each of the TM polarized lights, which have been input through the first and second optical lines 121 and 122, thereby generating polarization-independent lights having different wavelength bands. That is, the TE polarized light and TM polarized light of relevant wavelength bands output from the semiconductor optical active devices 111 and 112, respectively, are combined with each other to generate broadband lights, which have different wavelength bands.

The lights obtained through the combination are transmitted to the band separator 140 through the single-mode optical fiber 131. The band separator 140 separates and outputs the received light according to their wavelength bands.

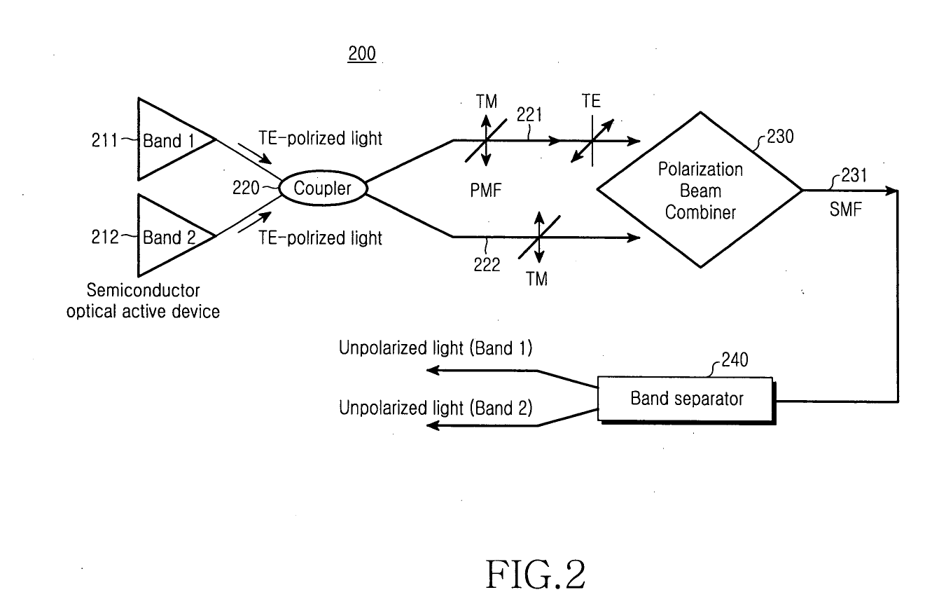

FIG. 2 is a block diagram illustrating the configuration of a broadband light source according to a second embodiment of the present invention.

As shown, the broadband light source 200 includes two or more semiconductor optical active devices 211 and 212, an optical coupler 220, first and second optical lines 221 and 222, a polarization beam combiner 230, a band separator 240, and a single-mode optical fiber 231. The single-mode optical fiber 231 is located between the polarization beam combiner 230 and the band separator 240, and transmits a polarization-independent light to the band separator 240.

The semiconductor optical active devices 211 and 212 generate TM polarized lights having wavelength bands different from each other and output the generated TM polarized lights to the optical coupler 220. The optical coupler 220 divides each of the TM polarized lights into two TM polarized lights, then outputs the two divided TM polarized lights (including a first TM polarized light and a second TM polarized light) to the first and second optical lines 221 and 222, respectively.

The first optical line 221 includes a polarization-maintaining optical fiber which is rotated 90° about the axis of the TM polarization. The first optical line 221 converts the first TM polarized light, which is one of the two divided TM polarized lights, into a TE polarized light, and outputs the converted TE polarized light to the polarization beam combiner 230. In contrast, the second optical line 222 outputs the second TM polarized light, which is the other of the two divided TM polarized lights, to the polarization beam combiner 230, while maintaining the polarization mode of the TM polarized light.

The polarization beam combiner 230 combines each TM polarized light and each TE polarized light of relevant wavelength bands, which have been input through the first and second optical lines 221 and 222, to generate broadband lights having different broad wavelength bands. The light obtained through the combination are separated and transmitted through the band separator 240

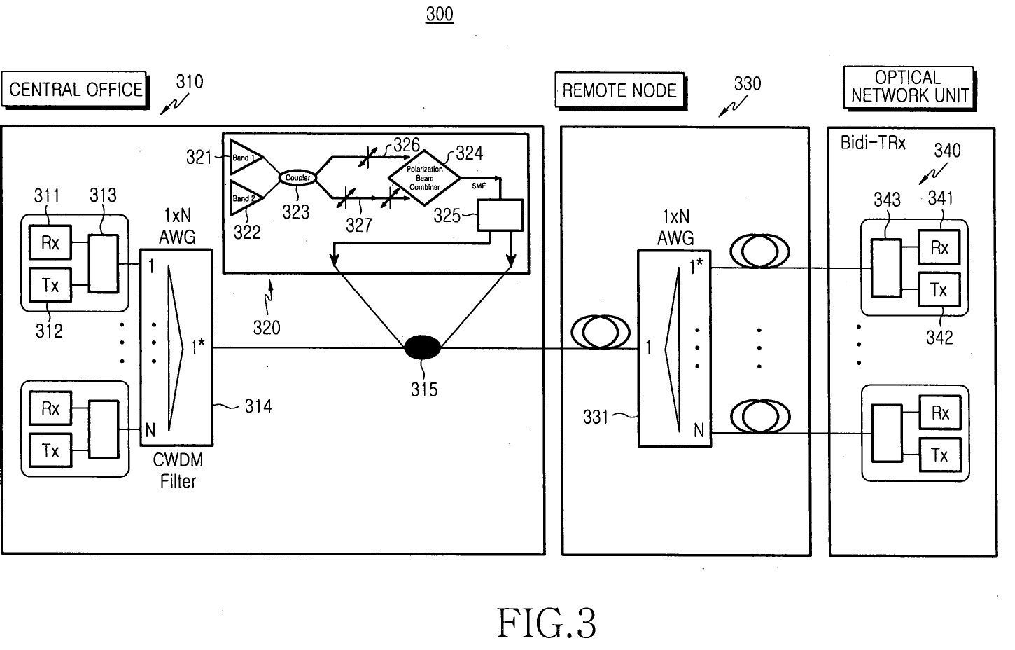

FIG. 3 is a block diagram illustrating a passive optical network including a broadband light source according to a third embodiment of the present invention. The passive optical network 300 includes a central office 310, a plurality of optical network units 340, and a remote node 330 located between the central office 310 and the optical network units 340. The central office 310 generates wavelength-locked downstream optical signals and also detects upstream optical signals, and each of the optical network units 340 receives a downstream optical signal of a relevant wavelength. The remote node 330 and the central office 310 are linked by a main optical fiber, and each of the optical network units 340 is linked to the remote node 330 by a local optical fiber.

The central office 310 includes a broadband light source 320, a plurality of downstream light sources 312, a plurality of upstream optical detectors 311, a plurality of wavelength selection combiners 313, a multiplexer/demultiplexer 314, and an optical switch 315.

The broadband light source 320 includes two or more semiconductor optical active devices 312 and 322, an optical coupler 323, first and second optical lines 326 and 327, a polarization beam combiner 324, and a band separator 325.

The semiconductor optical active devices 321 and 322 generate TE polarized lights having wavelength bands different from each other and output the generated TE polarized lights to the optical coupler 323.

The optical coupler 323 includes two input ports and two output ports. The optical coupler 323 divides each of the TE polarized lights into two TE polarized lights and outputs the two divided TE polarized lights (including a first TE polarized light and a second TE polarized light) to the first and second optical lines 326 and 327 connected to relevant output ports, respectively.

The first and second optical lines 326 and 327 may include a polarization-maintaining optical fiber. The first optical line 326 transmits the first TE polarized light, which is one of the two divided TE polarized lights, while maintaining the polarization mode of the first TE polarized light. In contrast, the second optical line 327 includes a polarization-maintaining optical fiber which is rotated 90° about the axis of the TE polarization. Therefore, the second optical line 327 converts the second TE polarized light, which is the other of the two divided TE polarized lights, into a TM polarized light, and outputs the TM polarized light.

The polarization beam combiner 324 combines each of the TE polarized lights and each of the TM polarized lights, which have been input through the first and second optical lines 326 and 327, to generate and output downstream and upstream lights having different wavelength bands.

The band separator 325 separates and outputs each of the downstream and upstream lights, which have been input through a single-mode optical fiber.

The broadband light source 320 may include a light source for generating TM polarized lights of different wavelength bands. That is, from the generated TM polarized lights, downstream and upstream polarization-independent lights having different wavelength bands can be generated in the same way as in the case of the TE polarized lights.

The above-mentioned broadband light source may be applied to the case in which the semiconductor optical active devices 321 and 322 generate TM polarized lights having different wavelength bands. In this case, each of the generated TM polarized lights is input to the optical coupler 323. The optical coupler 323 divides each of the TM polarized lights into two TM polarized lights and outputs the two divided TM polarized lights to the first and second optical lines 326 and 327.

The first optical line 326 outputs an input TM polarized light to the polarization beam combiner 324, while maintaining the mode of the input TM polarized light. The second optical line 327 converts an input TM polarized light into a TE polarized light and outputs the converted TE polarized light to the polarization beam combiner 324. That is, the second optical line 327 includes a polarization-maintaining optical fiber which is rotated 90° about the axis of the TE polarization, thereby converting input TM polarized lights into TE polarized lights. Thereafter, the broadband light source combines the TE and TM polarized lights with upstream and downstream lights having different wavelength bands.

The multiplexer/demultiplexer 314 divides the downstream light into a plurality of downstream channels having different wavelengths and outputs the divided lights to corresponding downstream light sources. Also, the multiplexer/demultiplexer 314 demultiplexes upstream optical signals, which has been multiplexed and input from the remote node 330, and outputs the demultiplexed upstream optical signals to corresponding upstream optical detectors 311. In addition, the multiplexer/demultiplexer 314 multiplexes and outputs downstream optical signals wavelength-locked by the downstream light sources 312 to the remote node 330.

Each of the downstream light sources 312 generates a downstream optical signal wavelength-locked by a corresponding downstream channel, and each of the upstream optical detectors 311 detects an upstream optical signal having a corresponding wavelength from among the demultiplexed upstream optical signals.

The optical switch 315 is located on the main optical fiber disposed between the multiplexer/demultiplexer 314 and the remote node 330, and is connected to the broadband light source 320. The optical switch 315 inputs and outputs multiplexed downstream and upstream optical signals. That is, the optical switch 315 outputs the downstream light to the multiplexer/demultiplexer 314, and outputs the upstream light to the remote node 330.

The remote node 330 divides the upstream light into a plurality of upstream channels having different wavelengths and outputs the divided light to corresponding optical network units 340, respectively. The remote node 330 multiplexes and outputs wavelength-locked upstream optical signals, which have received from the optical network units 340, to the central office 310. In addition, the remote node 330 demultiplexes and outputs multiplexed downstream optical signals, which have been input through the optical switch 315, to corresponding optical network units 340. The remote node 330 includes a multiplexer/demultiplexer 331, which may include an arrayed waveguide grating or a wavelength division multiplexing (WDM) filter.

Each of the optical network units 340 includes a wavelength selection combiner 343, an upstream light source 342, and a downstream optical detector 341. The wavelength selection combiner 343 outputs an upstream channel of a relevant wavelength to the upstream light source 342, and outputs an upstream optical signal wavelength-locked by the uplink channel in the upstream light source 342 to the remote node 330. In addition, the wavelength selection combiner 343 outputs a downstream optical signal of a relevant wavelength to the downstream optical detector 341.

The upstream light source 342 may include a Fabry-Perot laser and generates an upstream optical signal wavelength-locked by an upstream channel of a relevant wavelength. The downstream optical detector 341 may include a photo diode and detects a downstream optical signal of a relevant wavelength.

As described above, the broadband light source according to the present invention can generate a polarization-independent light which is not influenced by the polarization property of the semiconductor optical active device, and enables the semiconductor optical active device to easily generate broadband lights having different wavelength bands. Furthermore, since the broadband light source according to the present invention can be applied to the semiconductor optical active device, which can be easily integrated and manufactured in a compact size, it is easy to optimize and miniaturize the volume and configuration of a system to which the broadband light source is applied.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A broadband light source comprising:
at least two semiconductor optical active devices for generating TE polarized lights of different wavelength bands;
an optical coupler for dividing each of the TE polarized lights input from each of the semiconductor optical active devices into two TE polarized lights, and outputting the divided TE polarized lights including a first TE polarized light and a second TE polarized light;
a first optical line for transmitting the first TE polarized light, while maintaining a polarization mode of the first TE polarized light;
a second optical line for converting the second TE polarized light into a TM polarized light;
a polarization beam combiner for combining the first TE polarized light and the TM polarized light to generate a polarization-independent light; and
a band separator for separating and outputting the polarization-independent light according to wavelength bands.

2. The broadband light source as claimed in claim 1, further comprising a single-mode optical fiber which is disposed between the polarization beam combiner and the band separator and transmits the polarization-independent light to the band separator.

3. The broadband light source as claimed in claim 1, wherein the first optical line includes a polarization-maintaining optical fiber.

4. The broadband light source as claimed in claim 1, wherein the second optical line includes a polarization-maintaining optical fiber rotated 90° about an axis of a TE polarization.

5. The broadband light source as claimed in claim 1, wherein the semiconductor optical active devices comprises one of a superluminescent diode (SLD) and a semiconductor optical amplifier (SOA).

6. The broadband light source as claimed in claim 1, wherein the optical coupler comprises a 2×2 optical coupler.

7. A broadband light source comprising:
at least two semiconductor optical active devices for generating TM polarized lights of different wavelength bands;
an optical coupler for dividing each of the TM polarized lights input from each of the semiconductor optical active devices into two TM polarized lights, and outputting the the divided TM polarized lights including a first TM polarized light and a second TM polarized light;
a first optical line for converting the first TM polarized light into a TE polarized light;
a second optical line for transmitting the second TM polarized light, while maintaining a polarization mode of the second TM polarized light;
a polarization beam combiner for combining the TE polarized light and the second TE polarized light to generate a polarization-independent light; and
a band separator for separating and outputting the polarization-independent light according to wavelength bands.

8. The broadband light source as claimed in claim 7, further comprising a single-mode optical fiber disposed between the polarization beam combiner and the band separator and transmits the polarization-independent light to the band separator.

9. The broadband light source as claimed in claim 7, wherein the first optical line includes a polarization-maintaining optical fiber which is rotated 90° about an axis of a TM polarization.

10. The broadband light source as claimed in claim 7, wherein the second optical line includes a polarization-maintaining optical fiber.

11. The broadband light source as claimed in claim 7, wherein the semiconductor optical active devices comprises one of a superluminescent diode (SLD) and a semiconductor optical amplifier (SOA).

12. The broadband light source as claimed in claim 7, wherein the optical coupler comprises a 2×2 optical coupler.

13. A passive optical network comprising:
a central office;
a remote node linked to the central office via a main optical fiber; and
a plurality of optical network units linked to the remote node via corresponding local optical fibers, wherein the central office comprises:
a broadband light source for generating TE polarized lights of different wavelength bands, dividing each of the TE polarized lights into two TE polarized lights, converting one of the divided TE polarized lights into a TM polarized light, and combining each divided TE polarized light and each TM polarized light to generate downstream and upstream lights of different wavelength bands;
a plurality of downstream light sources for wavelength-locked downstream optical signals;
a plurality of upstream optical detectors for detecting upstream optical signals of relevant wavelengths, respectively;
a multiplexer/demultiplexer for multiplexing and outputting the downstream optical signals to the remote node, dividing the downstream light into a plurality of downstream channels to output corresponding downstream light sources, multiplexing and outputting downstream optical signals wavelength-locked by relevant downstream channels to the remote node, and demultiplexing and outputting multiplexed upstream optical signals to corresponding upstream optical detectors; and
an optical switch, disposed on the main optical fiber, for outputting the downstream light to the multiplexer/demultiplexer and outputting the upstream light to the remote node.

14. The passive optical network as claimed in claim 13, wherein the broadband light source comprises:
at least two semiconductor optical active devices for generating TE polarized lights of different wavelength bands;
an optical coupler for dividing each of the TE polarized lights input from each of the semiconductor optical active devices into two TE polarized lights, and outputting the the divided TE polarized lights including a first TE polarized light and a second TE polarized light;
a first optical line for transmitting the first TE polarized light, while maintaining a polarization mode of the first TE polarized light;
a second optical line for converting the second TE polarized light into a TM polarized light;
a polarization beam combiner for combining the first TE polarized light and the TM polarized light to generate a polarization-independent light; and
a band separator for separating and outputting the polarization-independent light according to wavelength bands.

15. The passive optical network as claimed in claim 13, wherein the broadband light source comprises:
at least two semiconductor optical active devices for generating TM polarized lights of different wavelength bands;
an optical coupler for dividing each of the TM polarized lights input from each of the semiconductor optical active devices into two TM polarized lights, and outputting the the divided TM polarized lights including a first TM polarized light and a second TM polarized light;
a first optical line for transmitting the first TM polarized light, while maintaining a polarization mode of the first TM polarized light;
a second optical line for converting the second TM polarized light into a TE polarized light;
a polarization beam combiner for combining the first TM polarized light and the TE polarized light to generate a polarization-independent light; and
a band separator for separating and outputting the polarization-independent light according to wavelength bands.

16. The passive optical network as claimed in claim 14, wherein the second optical line includes a polarization-maintaining optical fiber which is rotated 90° about an axis of a TE polarization.

17. The passive optical network as claimed in claim 15, wherein the second optical line includes a polarization-maintaining optical fiber which is rotated 90° about an axis of a TM polarization.

18. The passive optical network as claimed in claim 13, wherein the central office further comprises a plurality of wavelength selection combiners for coupling a corresponding downstream light source and upstream light detector to the multiplexer/demultiplexer.

19. The passive optical network as claimed in claim 14, wherein the semiconductor optical active devices comprises one of a superluminescent diode (SLD) and a semiconductor optical amplifier (SOA).

20. The passive optical network as claimed in claim 14, wherein the optical coupler comprises a 2×2 optical coupler.
